(19) United States
(12) Patent Application Publication
(10) Pub. No.: US 2023/0357046 A1
(43) Pub. Date: Nov. 9, 2023

(54) PEROVSKITES FOR REDUCTION-RE-OXIDATION THERMOCHEMICAL WATER AND CARBON DIOXIDE SPLITTING

(71) Applicants: Ellen B. Stechel, Albuquerque, NM (US); Emily A. Carter, Belle Mead, NJ (US); Sai Gautam Gautam Gopalakrishnan, Bengaluru (IN); Robert B. Wexler, Philadelphia, PA (US)

(72) Inventors: Ellen B. Stechel, Albuquerque, NM (US); Emily A. Carter, Belle Mead, NJ (US); Sai Gautam Gautam Gopalakrishnan, Bengaluru (IN); Robert B. Wexler, Philadelphia, PA (US)

(21) Appl. No.: 18/143,556

(22) Filed: May 4, 2023

Related U.S. Application Data
(60) Provisional application No. 63/338,093, filed on May 4, 2022.

(51) Int. Cl. C01G 45/12; C01B 3/06; C01B 32/40

(52) U.S. Cl. CPC C01G 45/1264; C01B 3/063; C01B 32/40; C01P 2002/50; C01P 2002/34

(57) ABSTRACT

A metal-oxide perovskite material having a general formula Ca₁₋ₓCeₓTi_{y}Mn_{1-y}O₃, where x is in a range of about 0.3 to about 0.35 and y is in a range of about 0.25 to about 0.35. Producing hydrogen and oxygen includes heating the metal-oxide perovskite material; reducing the metal-oxide perovskite material to yield a reduced metal-oxide perovskite material; cooling the reduced metal-oxide perovskite material; and contacting the reduced metal-oxide perovskite material with a re-oxidizing fluid including steam to yield hydrogen and a re-oxidized metal-oxide perovskite material. Producing carbon monoxide and oxygen includes heating the metal-oxide perovskite material; reducing the metal-oxide perovskite material to yield a reduced metal-oxide perovskite material; cooling the reduced metal-oxide perovskite material, and contacting the reduced metal-oxide perovskite material with a re-oxidizing fluid including carbon dioxide to yield carbon monoxide and a re-oxidized metal-oxide perovskite material.

### CROSS-REFERENCE TO RELATED APPLICATION

This application claims the benefit of U.S. Patent Application No. 63/338,093 filed on May 4, 2022, which is incorporated herein by reference in its entirety.

### STATEMENT OF GOVERNMENT SUPPORT

This invention was made with government support under grant number DE-EE0008090 awarded by the Department of Energy. The government has certain rights in the invention.

### TECHNICAL FIELD

This invention relates to metal-oxide perovskite materials used for thermochemical water and carbon dioxide splitting.

### BACKGROUND

Reduction-re-oxidation thermochemical cycles for water and carbon-dioxide splitting use recyclable chemical compounds and high temperatures sourced from concentrated solar power or other renewable pathways to split water into hydrogen and oxygen and carbon dioxide into carbon monoxide and oxygen, with no direct greenhouse gas emissions. Some metal oxides, such as CeO₂, have been used as recyclable reactants in these thermochemical cycles.

### SUMMARY

This disclosure describes a non-consumed reactant in a reduction-re-oxidation thermochemical cycle for water and carbon-dioxide splitting powered by a heat source. The reactant is a redox-active metal-oxide perovskite material generally referred to as a Ca—Ce—Ti—Mn oxide perovskite. A general formula of the metal-oxide perovskite material is Ca₁₋ₓCeₓTi_{y}Mn_{1-y}O₃, where x is in a range of about 0.3 to about 0.35 and y is in a range of about 0.25 to about 0.35. This metal-oxide perovskite material is generally referred to herein as Ca_{2/3}Ce_{1/3}Ti_{1/3}Mn_{2/3}O₃ or CCTM2112.

In a first general aspect, a metal-oxide perovskite material has a general formula Ca₁₋ₓCeₓTi_{y}Mn_{1-y}O₃, where x is in a range of about 0.3 to about 0.35 and y is in a range of about 0.25 to about 0.35.

Implementations of the first general aspect can include one or more of the following features.

In some cases, the metal-oxide perovskite material yields a reduced metal-oxide perovskite material in a reducing environment after heating to a reduction temperature, wherein 0.5>δr>0. The reduced metal-oxide perovskite material has a general formula Ca₁₋ₓCeₓTi_{y}Mn_{1-y}O_{3-δr}, wherein 0.5>δr>0. The reduction temperature is typically in a range of about 1600K to about 2000K. The reduced metal-oxide perovskite material yields a re-oxidized metal-oxide perovskite material and hydrogen when contacted with water at a re-oxidation temperature. The reduced metal-oxide perovskite material yields a re-oxidized metal-oxide perovskite material and carbon monoxide when contacted with carbon dioxide at a re-oxidation temperature. In some implementations, the reduced metal-oxide perovskite material yields a re-oxidized metal-oxide perovskite material and syngas when contacted with a re-oxidizing fluid including water and carbon dioxide at a re-oxidation temperature. The re-oxidized metal-oxide perovskite material has a general formula Ca₁₋ₓCeₓTi_{y}Mn_{1-y}O_{3-δo}, wherein 0<δo<δr. The re-oxidation temperature is typically in a range of about 900K to about 1500K.

In a second general aspect, producing hydrogen and oxygen includes a) heating a metal-oxide perovskite material; b) reducing the metal-oxide perovskite material to yield oxygen and a reduced metal-oxide perovskite material, where x is in a range of about 0.3 to about 0.35 and y is in a range of about 0.25 to about 0.35; c) cooling the reduced metal-oxide perovskite material; and d) contacting the reduced metal-oxide perovskite material with a re-oxidizing fluid including steam to yield hydrogen and a re-oxidized metal-oxide perovskite material. The reduced metal-oxide perovskite material has a general formula Ca₁₋ₓCeₓTi_{y}Mn_{1-y}O_{3-δr}, wherein 0.5>δr>0. The re-oxidized metal-oxide perovskite material has a general formula Ca₁₋ₓCeₓTi_{y}Mn_{1-y}O_{3-δo}, wherein 0<δo<δr.

Implementations of the second general aspect can include one or more of the following features.

In some cases, heating the metal-oxide perovskite material includes heating to a temperature in a range of about 1600K to about 2000K. Heating the metal-oxide perovskite material can include heating with concentrated solar energy or a radiant heat lamp. In some cases, reducing the metal-oxide perovskite material occurs in a reducing environment having a partial pressure of oxygen less than 0.01 bar. The reducing environment typically includes nitrogen, argon, steam, carbon dioxide, or any combination thereof. In certain cases, cooling the reduced metal-oxide perovskite material includes cooling to a temperature in a range of about 900K to about 1500K. The re-oxidizing fluid can further include carbon dioxide, and contacting the reduced metal-oxide perovskite material with the re-oxidizing fluid further yields carbon monoxide. Some implementations include repeating a)-d), wherein heating the metal-oxide perovskite material comprises heating the re-oxidized metal-oxide perovskite material.

In a third general aspect, producing carbon monoxide and oxygen includes a) heating a metal-oxide perovskite material; b) reducing the metal-oxide perovskite material to yield oxygen and a reduced metal-oxide perovskite material; c) cooling the reduced metal-oxide perovskite material; and d) contacting the reduced metal-oxide perovskite material with a re-oxidizing fluid including carbon dioxide to yield carbon monoxide and a re-oxidized metal-oxide perovskite material. The reduced metal-oxide perovskite material has a general formula Ca₁₋ₓCeₓTi_{y}Mn_{1-y}O_{3-δr}, wherein x is in a range of about 0.3 to about 0.35, y is in a range of about 0.25 to about 0.35, and 0.5>δr>0. The re-oxidized metal-oxide perovskite material has a general formula Ca₁₋ₓCeₓTi_{y}Mn_{1-y}O_{3-δo}, wherein 0<δo<δr.

Implementations of the third general aspect can include one or more of the following features.

In some cases, heating the metal-oxide perovskite material includes heating to a temperature in a range of about 1600K to about 2000K. Heating the metal-oxide perovskite material can include heating with concentrated solar energy or a radiant heat lamp. In some cases, reducing the metal-oxide perovskite material occurs in a reducing environment having a partial pressure of oxygen less than 0.01 bar. In some implementations, cooling the reduced metal-oxide perovskite material includes cooling to a temperature in a range of about 900K to about 1500K. The reducing environment typically includes an inert gas (e.g., nitrogen or argon), steam, carbon dioxide, or any combination thereof. In some cases, the re-oxidizing fluid further includes steam, and contacting the reduced metal-oxide perovskite material with the re-oxidizing fluid further yields hydrogen.

Ca—Ce—Ti—Mn oxide perovskites can improve the efficiency of hydrogen production (from water splitting) and carbon-monoxide production (from carbon-dioxide splitting) by tuning or optimizing the reduction enthalpy, the reduction entropy, or both. Quantum-based modeling of Ca_{2/3}Ce_{1/3}Ti_{1/3}Mn_{2/3}O₃ predicts that A-site Ce⁴⁺ reduction dominates the redox activity of the material. This metal-oxide perovskite also has desirable redox thermodynamics for metal-oxide water splitting and carbon-dioxide splitting for hydrogen and carbon dioxide production, respectively.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 depicts a general mechanism for thermochemical hydrogen production using a redox-active metal oxide.

FIG. 2 depicts the special quasirandom structure (SQS) for Pnma Ca_{2/3}Ce_{1/3}Ti_{1/3}Mn_{2/3}O₃ (CCTM2112) optimized using Hubbard-U-corrected density functional theory (DFT) based on the strongly constrained and appropriately normed (SCAN) exchange-correlation functional. Lattice constants are labeled as (a, b, and c).

### DETAILED DESCRIPTION

This disclosure describes a non-consumed reactant in a thermochemical cycle (TCC) for water and carbon-dioxide splitting that can be powered by renewable heat sources. The reactant is a redox-active metal-oxide perovskite material generally referred to as a Ca—Ce—Ti—Mn oxide perovskite. A general formula of the metal-oxide perovskite material is Ca₁₋ₓCeₓTi_{y}Mn_{1-y}O₃, where x is in a range of about 0.3 to about 0.35 and y is in a range of about 0.25 to about 0.35. This metal-oxide perovskite material is generally referred to herein as Ca_{2/3}Ce_{1/3}Ti_{1/3}Mn_{2/3}O₃ or CCTM2112, where “2112” indicates the relative composition of the material for three formula units or numerators of the fractional A- and B-site compositions for one formula unit.

Ca—Ce—Ti—Mn oxide perovskites can be employed in solar thermochemical reactors that use concentrated solar energy TCC redox reactions. Other examples of suitable heat sources include radiant heat lamps, low-carbon sources of electrically generated heat, and other renewable resources. The metal-oxide perovskite material is heated in an environment having a low partial pressure of oxygen to reduce one or more metals in the metal-oxide perovskite material and release molecular oxygen, producing oxygen vacancies in the material. After cooling, the reduced metal-oxide perovskite material can be contacted with steam, carbon dioxide, or both to re-oxidize the reduced metal-oxide perovskite material and yield molecular hydrogen (“hydrogen gas” or “hydrogen”), carbon monoxide, or syngas (hydrogen and carbon monoxide), respectively.

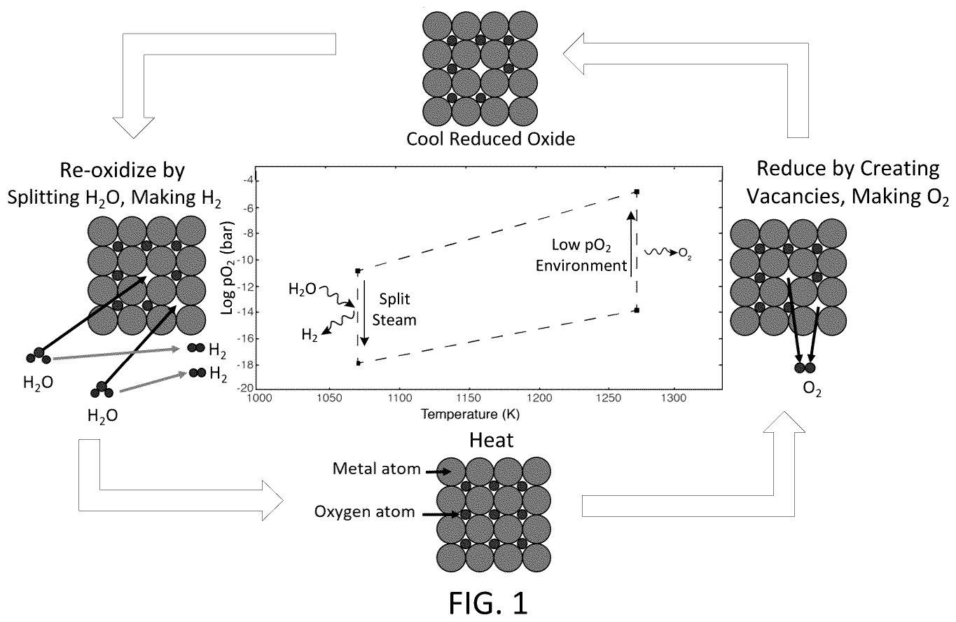

FIG. 1 illustrates a simplified TCC to generate thermochemical hydrogen. As depicted, a redox-active metal-oxide perovskite material (e.g., Ca_{2/3}Ce_{1/3}Ti_{1/3}Mn_{2/3}O₃) is heated (e.g., by absorption of radiation from concentrated solar energy). The metal-oxide perovskite material is heated to a reduction temperature, and is reduced in a reducing environment. As used herein, “reduction temperature” generally refers to a temperature sufficient to reduce the metal-oxide perovskite material in a reducing environment with a low partial pressure of oxygen (pO₂). In one example, a low pO₂ environment has a pO₂ of less than about 0.01 bar (e.g., between about 0.00001 bar and about 0.01 bar). The low pO₂ environment can include an inert gas (e.g., nitrogen or argon), steam, carbon dioxide, or any combination thereof. In some cases, the total pressure of the low pO₂ environment is less than 1 atmosphere. The reduction temperature is typically in a range of about 1600K to about 2000K. In some examples, heating to a reduction temperature includes following a predetermined heating profile. Heating the metal-oxide perovskite material to the reduction temperature results in oxygen vacancies in the metal-oxide perovskite material, yielding molecular oxygen (“oxygen gas” or “oxygen”) and a reduced form of the metal-oxide perovskite material (a “reduced metal-oxide perovskite material”). The reduced metal-oxide perovskite material has a general formula Ca₁₋ₓCeₓTi_{y}Mn_{1-y}O_{3-δr}, wherein 0.5>δr>0.

The reduced metal-oxide perovskite material is cooled in a low pO₂ environment to a re-oxidation temperature. As used herein, “re-oxidation temperature” generally refers to a temperature sufficient to re-oxidize the reduced metal-oxide perovskite material in the presence of steam (gaseous water), carbon dioxide, or both. The re-oxidation temperature is typically in a range of about 900K to about 1500K. In some examples, cooling to a re-oxidation temperature includes following a predetermined cooling profile. When the reduced metal-oxide perovskite material is at or above the re-oxidation temperature, it is contacted with a re-oxidizing fluid that includes steam, carbon dioxide, or both. In some cases, the re-oxidizing fluid includes small amounts (e.g., less than 0.5 vol %) of one or both of hydrogen and carbon monoxide.

As depicted in FIG. 1, contacting the reduced metal-oxide perovskite material with steam re-oxidizes the reduced metal-oxide perovskite material to yield a re-oxidized metal-oxide perovskite material, and also yields hydrogen during re-oxidation and yields oxygen during reduction. The re-oxidized metal-oxide perovskite material has a general formula Ca₁₋ₓCeₓTi_{y}Mn_{1-y}O_{3-δo}, wherein 0<δo<δr. In some implementations, the reduced metal-oxide perovskite material is contacted with carbon dioxide. Contacting the reduced metal-oxide perovskite material with carbon dioxide re-oxidizes the reduced metal-oxide perovskite material to yield a re-oxidized metal-oxide perovskite material, and also yields carbon monoxide during re-oxidation and yields oxygen during reduction. The re-oxidized metal-oxide perovskite material has a general formula Ca₁₋ₓCeₓTi_{y}Mn_{1-y}O_{3-δo}, wherein 0<δo<δr. In certain implementations, the reduced metal-oxide perovskite material is contacted with steam and carbon dioxide. Contacting the reduced metal-oxide perovskite material with steam and carbon dioxide re-oxidizes the reduced metal-oxide perovskite material to yield a re-oxidized metal-oxide perovskite material, and yields hydrogen and carbon monoxide (syngas) during re-oxidation and oxygen during reduction. The re-oxidized metal-oxide perovskite material has a general formula Ca₁₋ₓCeₓTi_{y}Mn_{1-y}O_{3-δo}, wherein 0<δo<δr.

The interior of FIG. 1 shows an example of a plot of the logarithm of pO₂ in a simplified TCC. The pO₂ is a function at least in part, of the temperature and pressure of the environment and an amount of components such as an inert gas (e.g., nitrogen or argon), hydrogen, carbon monoxide, steam, and carbon dioxide. The lower dotted line in the plot depicts heating at a constant δo. The upper dotted line in the plot depicts cooling at a constant Sr.

An example synthesis of and experimental data related to the TCC performance of CCTM2112 is provided in “Multiple and nonlocal cation redox in Ca—Ce—Ti—Mn oxide perovskites for solar thermochemical applications” (Robert B. Wexler et al., Energy Environ. Sci., 2023, Advance Article, May 3, 2023), which is incorporated by reference herein.

CCTM2112 is an A-site redox-active perovskite with multiple redox-active cations in the same compound and on different sublattices, and it is predicted to have a lower reduction enthalpy than CeO₂. Because reduction enthalpy influences redox capacity and water and carbon dioxide splitting efficiency, CCTM2112 is predicted to be an effective reactant in thermochemical reduction-re-oxidation cycles. Quantum-based modeling of CCTM2112 indicates that A-site Ce⁴⁺ reduction dominates the redox activity of the material.

The stability of CCTM2112 was computed as the energy above the convex hull (Eₕᵤₗₗ), which is the energy change upon decomposition of a material into stable compounds at the same composition. Hubbard-U-corrected density functional theory (DFT) calculations were performed with the strongly constrained and appropriately normed (SCAN) exchange-correlation functional. Based on a convex hull construction, CCM is thermodynamically metastable, with an Eₕᵤₗₗ=39 meV/atom at 0 K.

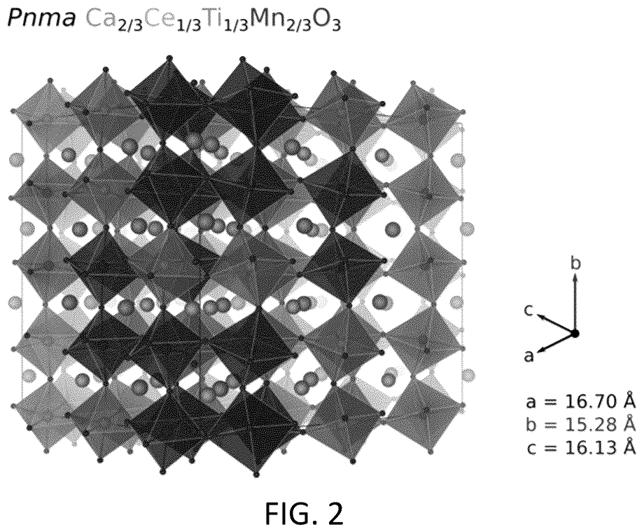

The structure of CCTM2112 is a Pnma Ca_{2/3}Ce_{1/3}Ti_{1/3}Mn_{2/3}O₃ solid solution, matching the Pnma structure of CaTiO₃. To simulate an experimentally realistic CCTM2112 solid solution, an optimized special quasirandom structure (SQS) was constructed with 360 atoms (216 of which are O atoms) and lattice constants of a=16.70 Å, b=15.28 Å, and c=16.13 Å, corresponding to supercell dimensions of 3×2×3, as shown in FIG. 2. As described herein, “optimized” generally refers to optimization of the lattice constants and optimization of the particular SQS to mimic the random alloy. SCAN+U calculations show that CCTM2112 has an ≈15% lower Eₕᵤₗₗ (=33 meV/atom, which is comparable to k_{B}298.15 K≈26 meV/atom) than the previously predicted CCM material, indicating improved stability. Other contributions to the stabilization of CCTM2112 may include configurational entropy (which is >41 meV/atom at 1273 K).

The energetics of oxygen vacancy (V_{O}) formation in CCTM2112 and its dependence on the V_{O}'s nearest neighbors (NNs) were analyzed. All 216 V_{O}s were categorized by their NN environment, and one V_{O} was randomly sampled (i.e., one V_{O} was introduced in the SQS, corresponding to δ=0.014) from each of the 13 unique V_{O} NN environments. This categorization also gave a tractable number of SCAN+U calculations from which to study the trends in the electronic and thermochemical properties of V_{O}s. NN V_{O} environments were defined using x_{Ce} and x_{Mn}, where x_{Ce}=N_{Ce}/(N_{Ca}+N_{Ce}), x_{Mn}=N_{Mn}/(N_{Ti}+N_{Mn}), and x (N) is the fraction (number) of the V_{O}'s four NN A-sites and two NN B-sites occupied by Ce (x_{Ce}=1−x_{Ca} and N_{Ce}=4−N_{Ca}) and Mn (x_{Mn}=1−x_{Ti} and N_{Mn}=2−N_{Ti}), respectively. The overall supercell structure maintained the same cation stoichiometry as that of bulk CCTM2112, with x_{Ce} and x_{Mn} strictly defining compositions that were local to the V_{O} considered. Predictably, the V_{O} with the highest frequency (f=44 or 44/216≈20% of the SQS) was the one with a NN environment closest to the bulk composition allowed by the A- and B-site NN fractions (x_{Ce}=0.25 and x_{Mn}=0.5 for the V_{O} and x_{Ce}=⅓ and x_{Mn}=⅔ for the bulk). Two NN V_{O} environments did not appear in the optimized SQS for CCTM2112 (namely those for x_{Ce}=1 and x_{Mn}≤0.5), however, V_{O}s with these NN environments are unlikely to significantly influence the macroscopic reduction of CCTM2112 due to their scarcity (x_{Ce}=1 and x_{Mn}=0.5, and x_{Ce}=1 and x_{Mn}=0 make up 0.5% and 0.1% of the random alloy, respectively).

With this V_{O} categorization protocol, five of the 13 V_{O}s were predicted have Eᵥs within (or within 0.06 eV of) the target range of 3.4-3.9 eV, including those with the first- and third-highest frequencies (f=44 or 44/216≈20% for x_{Ce}=0.25 and x_{Mn}=0.5, which is 17.6% in a random solid, and f=30 or 30/216≈14% for x_{Ce}=x_{Mn}=0.5, which is 13.2% of the sites in a random solid). To quantify the macroscopic reducibility of CCTM2112, the ensemble-averaged Eᵥ was calculated, with <Eᵥ>=ΣᵢfᵢE_{v,i}/Σᵢfᵢ, where fᵢ is the frequency of the i^{th} unique NN V_{O} environment, and Σᵢfᵢ=216. −Eᵥ>=3.30 eV was obtained with a standard deviation of 0.36 eV which overlaps with the target range for water splitting. While Eᵥ depended weakly on x_{Ce}, it systematically decreased with increasing x_{Mn}. This trend can be rationalized based on crystal O²⁻-Mⁿ⁺ bond dissociation energies E_{b}, an extension of molecular O-M bond dissociation energies to the solid state, defined as

$${E}_{b} [ {O}^{2 -} - {M}^{n +} ] = \frac{{E}_{c} [ {M O}_{n / 2} ]}{{N}_{b} [ {O}^{2 -} - {M}^{n +} ]} \qquad ( 1 )$$

where n is the oxidation state of the metal cation (M), E_{c}[MO_{n/2}] is the cohesive energy of the ground-state polymorph of the binary metal-oxide crystal MO_{n/2} containing Mⁿ⁺, and N_{b}[O²⁻-Mⁿ⁺] is the number of O²⁻-Mⁿ⁺ bonds per MO_{n/2} formula unit. In short, Eᵥ∝−x_{Mn} because O²⁻-Mn⁴⁺ (crystal bond dissociation energy E_{b}=2.25 eV) and O²⁻-Mn³⁺ (1.97 eV) crystal bonds are weaker than O²⁻—Ti⁴⁺ (3.16 eV) and O²⁻—Ti³⁺ (2.62 eV).

It can be advantageous to obtain a mechanistic understanding of the high performance of CCTM2112 compared to the structurally related CaTi_{0.5}Mn_{0.5}O_{3-δ} (CTM) and the Ce- and Mn-containing BCM perovskites. Because atomic magnetic moments (μ) are extremely sensitive measures of oxidation- and spin-state changes, these values were calculated for CCTM2112 and provided in Table 1. For fully oxidized CCTM2112, the mean magnetic moments imply that, rounded to the nearest integer, the average oxidation states of Ca, Ce, Ti, Mn, and O are 2+, 4+, 4+, 3+, and 2−, respectively, which leads to a charge neutral formula unit. Ce also can exist as Ce³⁺ and Mn as Mn⁴⁺ and Mn²⁺, where the latter suggests that disproportionation of two Mn³⁺ may occur in pristine CCTM2112.

TABLE 1
Magnetic moment summary statistics for
fully oxidized CCTM2112¹

| Element | Mean ± σ | Minimum | Maximum |
|---|---|---|---|
| Ca | 0.00 ± 0.00 (Ca²⁺) | 0.00 (Ca²⁺) | 0.00 (Ca²⁺) |
| Ce | 0.28 ± 0.23 (Ce⁴⁺) | 0.06 (Ce⁴⁺) | 0.68 (Ce³⁺) |
| Ti | 0.05 ± 0.02 (Ti⁴⁺) | 0.03 (Ti⁴⁺) | 0.08 (Ti⁴⁺) |
| Mn | 3.77 ± 0.24 (Mn³⁺) | 3.10 (Mn⁴⁺) | 4.50 (Mn²⁺) |
| O | 0.01 ± 0.01 (O²⁻) | 0.00 (O²⁻) | 0.05 (O²⁻) |

σ is the first standard deviation.
All values are in μB.

To gain greater insight into the nature of the electronic reorganization in CCTM2112 upon V_{O} formation in the thermal reduction step, the V_{O}-induced changes in the absolute values of μ_{Ce}, μ_{Mn}, and to were computed. (The use of absolute values controls for changes in relative orientation, e.g., ferromagnetic or antiferromagnetic). These |μ| value changes were then summed separately for Ce, Mn, and O to quantify the extent to which the A, B, and O sub-lattices, respectively, were reduced (positive value) or oxidized (negative value). These sums were calculated because changes in μ roughly correspond to changes in oxidation states, excluding Ca and Ti because insignificant spin changes were observed on these sites. Thus, the quantification of the number of electrons added to or removed from a species comes from the calculated changes in |μ|. For example, when x_{Ce}=0 and the change in |μ_{Ce}|≠0, a V_{O} without a NN Ce has reduced a non-NN Ce, thus resulting in nonlocal or delocalized reduction.

Computational results showed that reduction occurred primarily on the A-site Ce sub-lattice compared with that of Mn and O, regardless of the V_{O}'s NNs. In particular, the Ce sub-lattice reduced by 0.75 to 2.23 electrons depending on x_{Ce} and x_{Mn}, corresponding to an average decrease in Ce oxidation state of 0.031 to 0.093 electrons, respectively (average reduction of the 24 Ce in the unit cell). For Mn, no obvious net reduction or oxidation occurred during the formation of the V_{O}, with both mild reduction (≤0.35 electrons accepted) and oxidation (≤0.42 electrons donated) of Mn occurring simultaneously. During V_{O} formation, the O sublattice experienced weak-to-mild reduction (<0.52 electrons accepted in total by the O sub-lattice containing 216 atoms in the unit cell). The reduction of the O sub-lattice was indicative of empty O states in the pristine material, indicating that the Os were not fully ionized as O²⁻ (as indicated by Bader charge analysis), with instead the M-O bonds exhibiting some singlet-coupled covalent character, which spin-averaged the electrons on O to appear nonmagnetic.

Computational results indicated that Ce reduced even when it was not a nearest neighbor to the V_{O}. To better understand this phenomenon, the spatial dependence of the |μ| changes induced by a V_{O} with a Ca- and Mn-rich local environment (i.e., x_{Ce}=0 and x_{Mn}=1) was analyzed. Calculations indicated that two Ce were reduced (Δ|μ|=0.44 μ_{B} and 0.53 μ_{B}), at distances of 4.32 Å and 7.04 Å from the V_{O}, respectively. Ca and Ti are not redox active and only a few O were slightly reduced or became more ionic, mostly at distances of <5 Å from the V_{O}. Additionally, the Mn sub-lattice was both reduced and—to a slightly lesser extent—oxidized, leading to a net mild reduction of 0.35 electrons, corresponding to a disproportionation. Given that the changes for Mn were modest, experimental validation is non-trivial. Ce reduction-at-a-distance was also indicated by the difference between the electron density (ρ) of CCTM2112 with and without (i.e., in its pristine state) this same neutral V_{O} (Δρ=ρ_{vacancy}−ρₚᵣᵢₛₜᵢₙₑ), as electron density gain was observed emerging from and surrounding the two Ce atoms 4.32 Å and 7.04 Å away from the V_{O}. This nonlocal reduction allows a substantial fraction of the Ce present in the material to participate in oxygen vacancy formation and may partially explain the high extent of Ce reduction in CCTM2112.

The spatial dependence of V_{O}-induced reduction can be used to explain the subtle x_{Ce} dependence of Eᵥ at x_{Mn}=0. The value of Eᵥ for x_{Ce}=0 (4.25 eV) can be attributed to the localized reduction of Ce, and the electrostatic penalty associated with its distance (4.67-4.83 Å) from the holes localized on the V_{O}. For x_{Ce}=0.25, the Eᵥ≈3.58 eV is anomalously low because, while the reduction of Ce remains fairly localized (two Ce reduced at distances <5 Å to the V_{O}), these electrons are closer to the V_{O}-generated holes and therefore electrostatically stabilize the V_{O}. Strain can have an indirect effect on Eᵥ by inducing or relaxing Jahn-Teller distortions on Mn but the strain effect is difficult to quantify.

The highest value of Eᵥ (4.35 eV) was reached for x_{Ce}=0.5, which can result from the sum of the following: (1) an electrostatic penalty for delocalized reduction of Ce (four Ce reduced by >0.27 electrons at distances of 2.36 Å to 9.48 Å from the V_{O}) and the delocalized electrons' resultant screening of electron-hole interactions; and (2) a penalty for oxidizing the Mn (|Δμ|=−0.55 μ_{B}) at a distance of 10.01 Å from the V_{O}. From x_{Ce}=0.5 to x_{Ce}=0.75, Eᵥ decreases from 4.35 eV to 4.07 eV which, considering the latter's fairly delocalized reduction of Ce, may derive from the absence of oxidized Mn (i.e., Mn for which Δ|μ|<0 μ_{B}). Therefore, the subtle x_{Ce} dependence of Eᵥ at x_{Mn}=0 can be explained by the nature (localized versus delocalized) and location of V_{O}-generated charge carriers interacting electrostatically with the V_{O}.

The results of these computations indicate that Ce⁴⁺ functions as the primary acceptor of electrons even though it is generally less reducible than Mn⁴⁺ and Mn³⁺. To quantify the reducibility of Ce⁴⁺, Mn⁴⁺, and Mn³⁺, the enthalpy changes of the following solid-state reduction reactions were calculated: CeO₂→0.5 Ce₂O₃+0.25 O₂, MnO₂→0.5 Mn₂O₃+0.25O₂, and 0.5 Mn₂O₃→MnO+0.25O₂, respectively. Mn⁴⁺ is the most reducible cation (ΔH=0.40 eV) followed by Mn³⁺ (ΔH=1.02 eV) and then Ce⁴⁺ (ΔH=1.82 eV). Additionally, since these reactions are normalized per one-electron reduction, their ΔHs are effectively crystal reduction potentials (Vᵣ), which are a key factor governing Eᵥ in ternary oxide perovskites. While this simple analysis suggests that Ce should not reduce, the unoccupied states closest to the Fermi level in metallic CCTM2112 are Ce 4f states. Therefore, even though Ce⁴⁺ is less reducible than Mn⁴⁺ and Mn³⁺ in their ground-state binary oxides, Ce does reduce in CCTM2112 because there is a lower energy penalty for the structure to put the V_{O}-donated electrons in the Ce 4f states, even if the Ce atom is physically farther from the V_{O}. Ce⁴⁺ reduction is also accompanied by delocalization of electrons (due to the degeneracy of 4f states contributed by several Ce atoms close to the Fermi level), while Mn reduction is almost always localized, evidenced by the presence or absence of Jahn-Teller distortions associated with Mn³⁺. The need for 4f states near the Fermi level to reduce Ce⁴⁺ in the presence of Mn³⁺ is consistent with the observation that Mn and not Ce reduces during thermochemical cycling of Ba(Ce,Mn)O₃ (BCM) perovskite oxide (where Ba is on the A-site, and Ce and Mn occupy the B-site). Mn reduces in this example because BCM has a band gap and thus V_{O}-induced reduction is driven by cation proximity and reducibility rather than the relative location of unoccupied states near the Fermi level. Thus, the density of states for CCTM2112 promotes Ce reduction.

The high reducibility of Ce⁴⁺ in CCTM2112 is both advantageous to its high water-splitting performance and substantially different than the behavior of CeO₂ and other previously demonstrated Ce⁴⁺-containing off-stoichiometric redox-active materials. The existence of Ce⁴⁺ reduction is observed directly in modeling. One structural distinction of CCTM2112 is the 12-fold coordination of Ce⁴⁺ on the A-site, compared to the 8-fold coordination of Ce⁴⁺ in the CeO₂ fluorite structure and 6-fold coordination on the B-site of BCM.

Computational Details. Neutral oxygen vacancy formation energies were calculated using spin-polarized DFT as implemented in the Vienna Ab initio Simulation Package (VASP) version 5.4.4. DFT calculations were performed within the SCAN+U framework, where U were fit to relevant oxidation energies for Ce, Ti, V, Cr, Mn, Fe, Co, and Ni oxides. This framework provides superior predictions of bulk thermodynamics, band gaps, and magnetic configurations in comparison to PBE, PBE+U, and SCAN. All-electron, frozen-core, projector augmented-wave (PAW) potentials were utilized to describe the ion-electron interactions, including the non-spherical contributions related to the electron density gradient and the kinetic energy density within the PAW spheres for the XC evaluation. The Accurate “precision” mode was used in VASP to avoid aliasing errors when setting fast-Fourier-transform and support grids. An additional support grid was employed for the more accurate estimation of augmentation charges and the projection operators were evaluated in real space using VASP's fully automatic optimization scheme. The electronic wave function was expanded in a plane-wave basis with a kinetic-energy cutoff of 520 eV and only the Γ-point of the Brillouin zone was sampled due to the large size of the supercell (360 atoms). A Gaussian smearing function was applied with a width of 0.05 eV to improve self-consistent-field convergence. Collinear, spin-polarized calculations were performed and the atomic magnetic moments were initialized for the bulk in a ferromagnetic configuration with values of 0.6 μ_{B} for nominally nonmagnetic species (Ca²⁺, Ce⁴⁺, Ti⁴⁺, and O₂) and 4μ_{B} for Mn³⁺, which corresponds to its high spin state in an octahedral crystal field. For the vacancies, the atomic magnetic moments were initialized with bulk-optimized values.

Computational Prediction of Stability. To compute the stability of CCTM2112, its energy above the convex hull (Eₕᵤₗₗ) was calculated, where Eₕᵤₗₗ is the energy of decomposition into the set of most stable materials at its chemical composition. To calculate Eₕᵤₗₗ, the phase diagram code in pymatgen and SCAN+U total energies (Eₜₒₜ) of materials containing Ca, Ce, Ti, Mn, and O were used. This code takes as input the total energies and compositions of these materials and returns the list of stable compositional coordinates in the phase diagram, where a stable compositional coordinate is a set of compounds in equilibrium that define the chemical potentials of Ca, Ce, Ti, Mn, and O and that are on the convex hull. The results show that CCTM2112 is metastable at 0 K, with an Eₕᵤₗₗ of 33 meV/atom, i.e., a ΔE for its decomposition reaction of

Ca₂Ce₁Ti₁Mn₂O₉→⅓Mn₂O₃+⅔CaMn₂O₄+⅓Ca₄Ti₃O₁₀+CeO₂ (2)

where the products are the solid phases stable at Ca, Ce, Ti, Mn, and O mole fractions of 2/15, 1/15, 1/15, 2/15, and 9/15, respectively, and 0 K. 33 meV/atom is approximately equal to thermal energy at 298.15 K (i.e., k_{B}T=26 meV/atom).

Table 2 provides a comparison of the probability (Pr) and percentage (probability expressed as %) of all unique NN V_{O} environments, where x_{S} and N_{S} are the mole fraction and number of species S in the NN V_{O} environment, respectively, in the random alloy and the optimized SQS for Pnma CCTM2112 (% in SQS). If the site occupancy follows the binomial distribution, the probability of the V_{O} having exactly k_{S} NNs of species S in N noninteracting sites is given by

$$( \begin{matrix}N \\ {k}_{s}\end{matrix} ) {{p}_{S}^{{k}_{S}} ( 1 - {p}_{S} )}^{N - {k}_{S}} \cdot ( \begin{matrix}N \\ {k}_{S}\end{matrix} ) = \frac{N !}{{k}_{S} ! ( N - {k}_{S} ) !}$$

is the binomial coefficient and p_{S} is probability of choosing S based on the composition (p_{Ce}=⅓ and p_{Mn}=⅔). Pr(A) and Pr(B) are the probability of the NN A- and B-site combination, respectively, and Pr=Pr(A)×Pr(B).

$$Pr ( A ) = ( \begin{matrix}4 \\ 4 {x}_{C e}\end{matrix} ) {( \frac{1}{3} )}^{4 {x}_{Ce}} {( \frac{2}{3} )}^{4 ( 1 - {x}_{Ce} )}$$

$$and Pr ( B ) = ( \begin{matrix}2 \\ 2 {x}_{M n}\end{matrix} ) {( \frac{2}{3} )}^{2 {x}_{Mn}} {( \frac{1}{3} )}^{2 ( 1 - {x}_{Mn} )} ,$$

where k_{Ce}=4×_{Ce} (because each V_{O} has N=4 A-site NNs) and k_{Mn}=2×_{Mn} (because each V_{O} has N=2 B-site NNs). The x_{Ce}=1 and x_{Mn}=0 NN environment does not appear in the SQS because its frequency in the random alloy is 0.30, i.e., <1 out of 216 atoms. The x_{Ce}=1 and x_{Mn}=0.5 NN environment does not appear in the SQS because it was randomly selected instead of the x_{Ce}=1 and x_{Mn}=1 NN environment, which has the same probability in the random alloy.

TABLE 2
Comparison of the probability (Pr) and percentage
of all unique NN V_{O} environments.

| x_{Ce} | x_{Mn} | N_{Ca} | N_{Ce} | Pr(A) | N_{Ti} | N_{Mn} | Pr(B) | Pr | % | % in SQS |
|---|---|---|---|---|---|---|---|---|---|---|
| 0.00 | 1.00 | 4 | 0 | 0.20 | 0 | 2 | 0.44 | 0.09 | 8.8% | 10.2% |
| 0.00 | 0.50 | 4 | 0 | 0.20 | 1 | 1 | 0.44 | 0.09 | 8.8% | 7.4% |
| 0.00 | 0.00 | 4 | 0 | 0.20 | 2 | 0 | 0.11 | 0.02 | 2.2% | 1.9% |
| 0.25 | 1.00 | 3 | 1 | 0.40 | 0 | 2 | 0.44 | 0.18 | 17.6% | 16.2% |
| 0.25 | 0.50 | 3 | 1 | 0.40 | 1 | 1 | 0.44 | 0.18 | 17.6% | 20.4% |
| 0.25 | 0.00 | 3 | 1 | 0.40 | 2 | 0 | 0.11 | 0.04 | 4.4% | 4.2% |
| 0.50 | 1.00 | 2 | 2 | 0.30 | 0 | 2 | 0.44 | 0.13 | 13.2% | 11.1% |
| 0.50 | 0.50 | 2 | 2 | 0.30 | 1 | 1 | 0.44 | 0.13 | 13.2% | 13.9% |
| 0.50 | 0.00 | 2 | 2 | 0.30 | 2 | 0 | 0.11 | 0.03 | 3.3% | 3.2% |
| 0.75 | 1.00 | 1 | 3 | 0.10 | 0 | 2 | 0.44 | 0.04 | 4.4% | 5.1% |
| 0.75 | 0.50 | 1 | 3 | 0.10 | 1 | 1 | 0.44 | 0.04 | 4.4% | 3.7% |
| 0.75 | 0.00 | 1 | 3 | 0.10 | 2 | 0 | 0.11 | 0.01 | 1.1% | 1.4% |
| 1.00 | 1.00 | 0 | 4 | 0.01 | 0 | 2 | 0.44 | 0.01 | 0.5% | 1.4% |
| 1.00 | 0.50 | 0 | 4 | 0.01 | 1 | 1 | 0.44 | 0.01 | 0.5% | 0.0% |
| 1.00 | 0.00 | 0 | 4 | 0.01 | 2 | 0 | 0.11 | 0.00 | 0.1% | 0.0% |

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this depiction should not be understood as requiring that such operations be performed in the particular order shown or in sequential order, or that all illustrated operations be performed (some operations may be considered optional or modified), to achieve desirable results.

Accordingly, the previously described example embodiments do not define or constrain this disclosure. Other changes, substitutions, and alterations are also possible without departing from the spirit and scope of this disclosure.

What is claimed is:

1. A metal-oxide perovskite material having a general formula Ca₁₋ₓCeₓTi_{y}Mn_{1-y}O₃, wherein x is in a range of about 0.3 to about 0.35 and y is in a range of about 0.25 to about 0.35.

2. The metal-oxide perovskite material of claim 1, wherein the metal-oxide perovskite material yields a reduced metal-oxide perovskite material having a general formula Ca₁₋ₓCeₓTi_{y}Mn_{1-y}O_{3-δr} in a reducing environment after heating to a reduction temperature, wherein 0.5>δr>0.

3. The metal-oxide perovskite material of claim 2, wherein the reduction temperature is in a range of about 1600K to about 2000K.

4. The metal-oxide perovskite material of claim 2, wherein the reduced metal-oxide perovskite material yields a re-oxidized metal-oxide perovskite material having a general formula Ca₁₋ₓCeₓTi_{y}Mn_{1-y}O_{3-δo} and hydrogen when contacted with water at a re-oxidation temperature, wherein 0<δo<δr.

5. The metal-oxide perovskite material of claim 4, wherein the re-oxidation temperature is in a range of about 900K to about 1500K.

6. The metal-oxide perovskite material of claim 2, wherein the reduced metal-oxide perovskite material yields a re-oxidized metal-oxide perovskite material having a general formula Ca₁₋ₓCeₓTi_{y}Mn_{1-y}O_{3-δo} and carbon monoxide when contacted with carbon dioxide at a re-oxidation temperature, wherein 0<δo<δr.

7. The metal-oxide perovskite material of claim 6, wherein the re-oxidation temperature is in a range of about 900K to about 1500K.

8. The metal-oxide perovskite material of claim 2, wherein the reduced metal-oxide perovskite material yields a re-oxidized metal-oxide perovskite material having a general formula Ca₁₋ₓCeₓTi_{y}Mn_{1-y}O_{3-δo} and syngas when contacted with a re-oxidizing fluid comprising water and carbon dioxide at a re-oxidation temperature, wherein 0<δo<δr.

9. The metal-oxide perovskite material of claim 8, wherein the re-oxidation temperature is in a range of about 900K to about 1500K.

10. A method of producing hydrogen and oxygen, the method comprising:
a) heating a metal-oxide perovskite material;
b) reducing the metal-oxide perovskite material to yield oxygen and a reduced metal-oxide perovskite material having a general formula Ca₁₋ₓCeₓTi_{y}Mn_{1-y}O_{3-δr}, wherein x is in a range of about 0.3 to about 0.35, y is in a range of about 0.25 to about 0.35, and 0.5>δr>0;
c) cooling the reduced metal-oxide perovskite material; and
d) contacting the reduced metal-oxide perovskite material with a re-oxidizing fluid comprising steam to yield hydrogen and a re-oxidized metal-oxide perovskite material having a general formula Ca₁₋ₓCeₓTi_{y}Mn_{1-y}O_{3-δo}, wherein 0<δo<δr.

11. The method of claim 10, wherein heating the metal-oxide perovskite material comprises heating to a temperature in a range of about 1600K to about 2000K.

12. The method of claim 10, wherein cooling the reduced metal-oxide perovskite material comprises cooling to a temperature in a range of about 900K to about 1500K.

13. The method of claim 10, wherein heating the metal-oxide perovskite material comprises heating with concentrated solar energy or a radiant heat lamp.

14. The method of claim 10, wherein reducing the metal-oxide perovskite material occurs in a reducing environment having a partial pressure of oxygen less than 0.01 bar.

15. The method of claim 14, wherein the reducing environment comprises nitrogen, argon, steam, carbon dioxide, or any combination thereof.

16. The method of claim 10, wherein the re-oxidizing fluid further comprises carbon dioxide, and contacting the reduced metal-oxide perovskite material with the re-oxidizing fluid further yields carbon monoxide.

17. The method of claim 10, further comprising repeating a)-d), wherein heating the metal-oxide perovskite material comprises heating the re-oxidized metal-oxide perovskite material.

18. A method of producing carbon monoxide and oxygen, the method comprising:
a) heating a metal-oxide perovskite material;
b) reducing the metal-oxide perovskite material to yield oxygen and a reduced metal-oxide perovskite material having a general formula Ca₁₋ₓCeₓTi_{y}Mn_{1-y}O_{3-δr}, wherein x is in a range of about 0.3 to about 0.35, y is in a range of about 0.25 to about 0.35, and wherein 0.5>δr>0;
c) cooling the reduced metal-oxide perovskite material; and
d) contacting the reduced metal-oxide perovskite material with a re-oxidizing fluid comprising carbon dioxide to yield carbon monoxide and a re-oxidized metal-oxide perovskite material having a general formula Ca₁₋ₓCeₓTi_{y}Mn_{1-y}O_{3-δo}, wherein 0<δo<δr.

19. The method of claim 18, wherein heating the metal-oxide perovskite material comprises heating to a temperature in a range of about 1600K to about 2000K.

20. The method of claim 18, wherein cooling the reduced metal-oxide perovskite material comprises cooling to a temperature in a range of about 900K to about 1500K.

21. The method of claim 18, wherein heating the metal-oxide perovskite material comprises heating with concentrated solar energy or a radiant heat lamp.

22. The method of claim 18, wherein reducing the metal-oxide perovskite material occurs in a reducing environment having a partial pressure of oxygen less than 0.01 bar.

23. The method of claim 22, wherein the reducing environment comprises nitrogen, argon, steam, carbon dioxide, or any combination thereof.

24. The method of claim 18, wherein the re-oxidizing fluid further comprises steam, and contacting the reduced metal-oxide perovskite material with the re-oxidizing fluid further yields hydrogen.

25. The method of claim 18, further comprising repeating a)-d), wherein heating the metal-oxide perovskite material comprises heating the re-oxidized metal-oxide perovskite material.
